(19) United States
(12) Patent Application Publication
(10) Pub. No.: US 2010/0185568 A1
(43) Pub. Date: Jul. 22, 2010

(54) Method and System for Document Classification

(75) Inventors: Keith M. Bates, Toronto (CA); Jiang Su, Ottawa (CA); Bo Xu, Toronto (CA); Biao Wang, Toronto (CA)

Correspondence Address: VENABLE LLP, P.O. BOX 34385, WASHINGTON, DC, 20043-9998, US

(73) Assignee: Kibboko, Inc., Toronto (CA)

(21) Appl. No.: 12/355,945

(22) Filed: Jan. 19, 2009

(51) Int. Cl. G06F 15/18; G06F 17/30; G06N 5/02

(52) U.S. Cl. 706/12; 707/E17.014; 706/46

(57) ABSTRACT

A system and method to classify web-based documents as articles or non-articles is disclosed. The method generates a machine learning model from a human labelled training set which contains articles and non-articles. The machine learning model is applied to new articles to label them as articles or non-articles. The method generates the machine learning model based on content, such as text and tags of the web-based documents. The invention also provides for devices which incorporate the machine learning model, allowing such devices to classify documents as articles or non-articles.

### FIELD OF THE INVENTION

This invention relates to a computer-implemented system and method for classifying the content of documents.

### BACKGROUND OF THE INVENTION

On-line sources of content often contain marginal or inapplicable content. Even where an on-line source of content, such as a web or HTML page, has applicable content, such as a useful or relevant article, there is often a lot of inapplicable content on the same page. For example, a web page may contain information displayed across various parts of the page. The applicable content, such as an article of interest, may be located on just a portion of the page. Other parts of the page, such as the header, footer, or side portions might contain a list of links or banner ads that are not of interest and contain inapplicable content. The page may include other documents that are not of interest and contain inapplicable content which could include system warnings, contact information and the like. When a user visits, accesses or downloads a given document returned by a search engine which has been provided with a keyword search, he or she may be frustrated because the document contains inapplicable content. Further,when a search returns a HTML page, time may be wasted distinguishing useful articles from non-articles which are located on the page.

Users also have to deal with the challenging problem of information overload as the amount of online data increases by leaps and bounds in non-commercial domains, e.g., research paper searching.

Search engines tend to return many documents or pages in response to a query. Sometimes a generic query will return thousands of possible pages. As well, many pages identified by a search or recommendation engine, or in a list of documents or catalog, are often irrelevant or only marginally relevant to the person carrying out the search. As such use of search and recommendation engines tends to often be an inefficient use of time, produce poor results, or be frustrating. As well, search engines may identify a search term in a non-article portion of a page, even when the article is unrelated to the search term. This can also cause poor, unreliable or inefficient search results.

As well, such irrelevant or only marginally relevant web pages or documents can also reduce the performance of text classification search or recommendation systems and methods, when they are input in such systems and methods.

A person could label a document as “article” or “non-article” after the person has reviewed, at least in part, the article or content. There are some significant disadvantages to this approach. First, human labeling can be very expensive and time consuming. Using people to manually label content has the further disadvantage that it does not scale up well to handle large numbers of documents. This approach suffers the further disadvantage that it is not well-suited to handle a continuous stream of requests to label documents as “articles” or “non-articles”.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a computer-implemented system and method of document classification that can distinguish between articles and other web pages which contain non-article (i.e. irrelevant or marginal) content.

In one embodiment, the invention provides a computer-implemented method for labelling web documents as articles or non-articles comprising the steps of receiving a training set comprising documents, receiving a set of human generated labels for each document in the training set, generating a machine learning model based on the content of the document and the corresponding human generated label to generate a predicted label for the document, receiving a new document, applying the machine learning model to the new document to produce a label of article or non-article, and, associating the produced label with the new document.

In a further embodiment, the invention teaches an apparatus for article-non-article text classification comprising: means for receiving a new document, means for parsing the document according to tags, means for applying a machine learning model to each tag of the document to determine if the tag or the document contains text,and, means for labelling the document as an article if the means for apply a machine learning model has determined that the tag or the document contains text.

In a further embodiment, the invention discloses an apparatus for document classification comprising: an input processor, for receiving a new document; memory, for storing the new document and a machine learning model; and, a processor, for determining tags or other metrics in the new document and for applying the machine learning model to the tags or other metrics to produce a label of article or non-article.

### LIST OF FIGURES

FIG. 1 shows a schematic of web based documents, their contents and vectors calculated therefrom.

FIG. 2 is a block diagram illustrating the method and system of an embodiment of the present invention.

FIG. 3 is an example of a decision tree according to a method or system of an embodiment of the present invention.

FIG. 4 is a block diagram showing a further embodiment of the present invention.

FIG. 5 shows a basic computing system on which the invention can be practiced.

FIG. 6 shows the internal structure of the computing system of FIG. 5.

### DETAILED DESCRIPTION

Online learning provides an attractive approach to classification of documents as articles or non-articles. Online learning has the ability to take just a bit of knowledge and use it. Thus, online learning can start when few training data are available. Furthermore, online learning has the ability to incrementally adapt and improve performance while acquiring more and more data.

Online learning is especially useful in classifying documents as articles or non-articles. Although web page content can be stable for long periods of time, changes such as improvements and refinements to hypertext mark-up language (HTML) may occur from time to time. Online learning is capable of not only making predictions in real time but also tracking and incrementally evaluating web page content.

As used in this application, the terms “approach”, “module”, “component”, “classifier”, “model”, “system”, and the like are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the internet with other systems via the signal).

The system and method for text classification is suited for any computation environment. It may run in the background of a general purpose computer. In one aspect, it has CLI (command line interface), however, it could also be implemented with a GUI (graphical user interface), or could run as a background component or as middleware.

A HTML page consists of many predefined HTML tags, which are compliant to W3c guidelines. The following is a HTML source code snippet:
<h2>Familyshopping<imgsrc=“http://s7.addthis.com/button1-bm.gif” width=“125”height=“16”border=“0”alt=“BookmarkandShare”/><h2>

The general outline of the invention comprises the following steps or components (which will be described in greater detail below):
(a) Store a selection of documents (or the contents of web-pages) into a database, this selection being known as the Training Set;
(b) Human-label the documents as article or non-article;
(c) Select from amongst a further set of documents a sub-set of the most frequently occurring tags for web documents;
(d) Generate Further Training Sets, by randomly selecting documents from the Training Set;
(e) Calculate the Information Gain for the tags in each instance of the Further Training Sets;
(f) Generate a Decision Tree Model for each instance of the Further Training Set;
(g) Aggregate the Decision Tree Model to create an Aggregated (Bagging) Decision Tree Model;
(h) Receive a new document and determine tags and metrics for the new document;
(i) Use the Aggregated (Bagging) Decision Tree Model to determine whether a new document is an article or non-article and generate either an article or non-article label;
(j) Associate the article/non-article label with the new document and store such an association.

As a further step of the invention, prior to a selection of documents (or the contents of web-pages) into a database, this selection being known as the Training Set, an initial filtering could be carried out to filter out pages with suffixes such as “.mp3”, “.mov” or other suffixes indicating non-text documents etc., to filter out documents having a lower probability of being a document.

The steps described above are now described in greater detail.

Store a Selection of Documents (or the Contents of Web-Pages) into a Database, this Selection being known as the Training Set

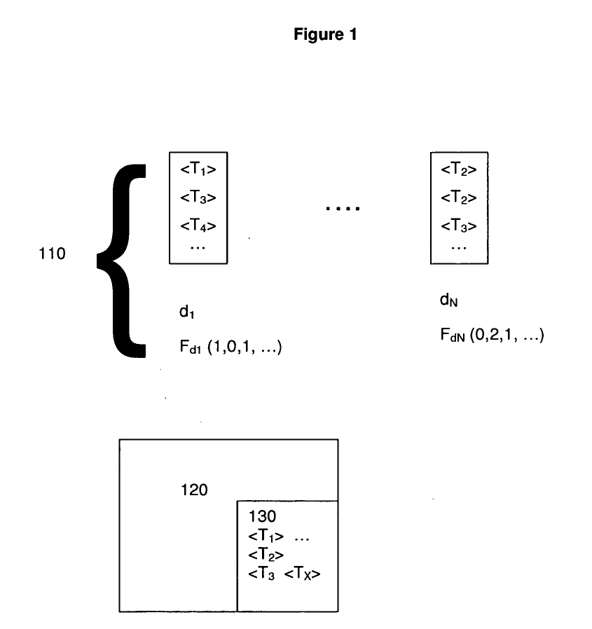

In a first step 210 of the invention, a training set 110 shown in FIG. 1 comprising documents d₁ . . . dₙ is stored in database 120. The training set 110 comprises a number of articles and non-articles, for example, one hundred (n=100) in aggregate. To improve the accuracy and effectiveness of the bagging decision trees, documents with suffixes such as “mp3” are excluded from the training set.

In one embodiment, an open source crawler JOBO has been used to find documents and store them in database 120. In the preferred embodiment, JOBO has been made multi-threading. In order to carry out multi-threaded activity, the URL of each document to be downloaded is stored on a task list. Two or more instances of JOBO are instantiated. Each instance of JOBO takes a document from the task list, downloads the HTML code and text for the document and stores the code and text in database 120. When this task is complete the URL is deleted from the task list. To improve the accuracy and effectiveness of the invention, before downloading the document the suffix of the document is examined and documents with suffixes such as “mp3” are excluded from the training set.

### Human-Label the Documents as Article or Non-Article

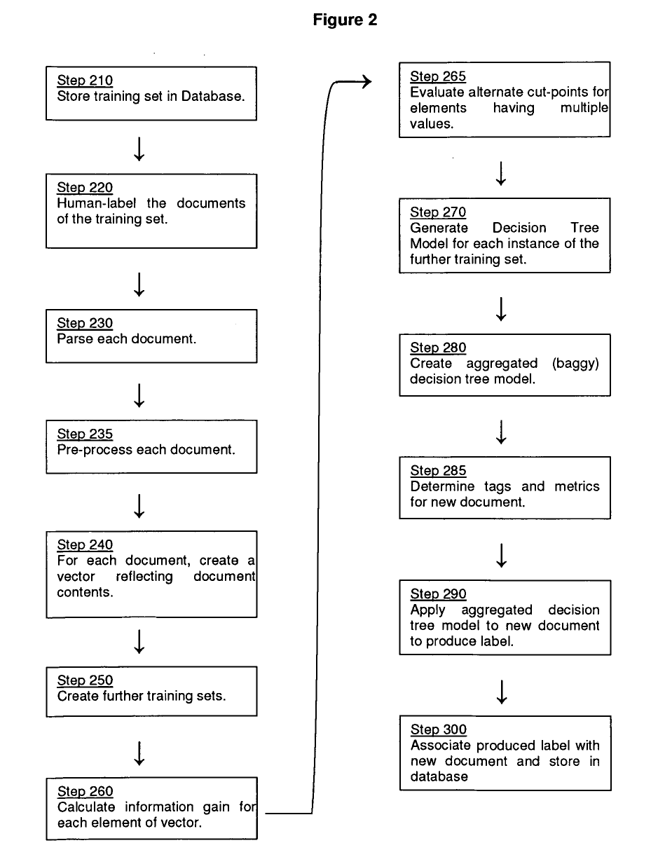

In the second step 220 of FIG. 2, one or more persons label the documents in the training set 110 as either articles or non-articles. The labels are stored in association with documents d₁ . . . dₙ in database 120.

### Selection of the Most Frequently Occurring Tags

In the third step 230 of FIG. 2, the documents d₁ . . . dₙ are examined (parsed) to see if they contain any of a set 130 of frequently occurring tags or html code (in FIG. 1, set 130 is shown stored in database 120). This set of frequently occurring tags or html code may be input based on operator judgment, published listings of frequently used tags or code, or, in a preferred embodiment, may be the X most frequently found tags in a second group of documents, T₁ . . . Tₓ. In one embodiment X=1300 and the second group of documents, not shown, consisted of about 160,000 documents. In this embodiment, all tags were selected when they occurred 100 times or more in the group of 160,000 documents. As can be appreciated by a person skilled in the art, other approaches could also be selected, for example choosing the tags occurring most often in the second group of documents. A further advantage of the present invention is that if new tags are used, for example, as new html protocols or versions such as W3C are implemented, it will be simple to recalculate the tags which most frequently occur.

In an alternate embodiment of the present invention the document may optionally be pre-processed in step 235. The data pre-processing 235 may comprise stop-word deletion, stemming and title and link extraction, which transforms or presents each article as a document vector in a bag-of-words data structure. With stop-word deletion, selected “stop” words (i.e. words such as “an”, “the”, “they” that are very frequent and do not have discriminating power) are excluded. The list of stop-words can be customized. Stemming converts words to the root form, in order to define words that are in the same context with the same term and consequently to reduce dimensionality. Such words may be stemmed by using Porter's Stemming Algorithm but other stemming algorithms could also be used. Text in links and titles from web pages can also be extracted and included in a document vector.

For each document, in step 240 of the invention a vector is created, setting out the frequency of occurrence of each of the X most frequently found tags. In other words for each d₁ . . . dₙ a vector is created {F₁, F₂ . . . F_{X}}, where F₁ represents the frequency in the document of the most frequently found tag, T₁; F₂ represents the frequency in each of the documents d₁ . . . dₙ of the second most frequently found tag, T₂, etc. As is illustrated in FIG. 1, the vector F_{d1} associated with documents d₁ contains the elements 1, 0, 1, . . . . In a preferred embodiment, the vector may also contain other metrics or measurements that describe the document. For example, in a preferred embodiment, the entropy of each document will be calculated. To calculate the entropy of the document, the frequency of occurrence of each word in the text portion of the document is determined. The entropy is determined using the following formula:

Entropy=Σ(probability of a word occurring in the document)*log (probability of a word occurring in the document). The summation occurs over all the words in the document.

Other numeric metrics could also be used as a component of the vector such as the word count of text in the document.

The vector is stored in association with the human generated label of the document as article or non-article.

Generate Further Training Sets, by Randomly Selecting Documents from the Training Set

In a preferred embodiment, further training sets in step 250 are created by randomly selecting a pre-determined number of documents from documents d₁ . . . dₙ, permitting any document or document to be selected zero, one or more times. These further training sets are stored in database 120.

Calculate the Information Gain for the Tags in each Instance of the Further Training Sets

In step 260 of FIG. 2 the Information Gain is calculated for each of the tags T₁ to T_{X} for each instance of a training set within the Further Training Sets. The Information Gain is used to select features (tags or numeric metrics) with the most power to discriminate between articles and non-articles.

The formula for calculating the Information Gain is given as follows:

$$Information Gain = - ( {\sum }_{y} p ( y ) * log p ( y ) ) - {\sum }_{a} p ( a ) * ( {\sum }_{y} p ( y \vert a ) * log p ( y \vert a ) )$$

(where the summation is taken over the y terms)
Example
Let us assume that there are 100 documents in the training set. 40 of the documents have been human labelled as articles (and thus 60 are human-labelled as non-articles.)
Let us further assume that there is a tag, namely, T₁. Of the 100 documents in the training set 70 contain T₁ and 30 do not contain T₁. Of the 70 that contain T₁, 40 are human-labelled as articles and 30 as non-articles. Of the 30 that do not contain T₁, 20 are human-labelled as non-articles and 10 as articles.
Thus the Information Gain for T₁ is calculated as follows:

IG(T₁)=((−70/100)*(4/7*log 4/7+3/7 log (3/7))−((30/100)*(2/3*log(2/3)+1/3 log (1/3))

In a preferred embodiment, for simplicity of calculation, if a particular tag, for example, T₁, occurs more than once in a document, it is deemed to have occurred only once. In other words, for the purpose of calculating the Information Gain, any particular tag is either present or not present.

In an alternate embodiment, the information gain can be calculated according to each different frequency of the tag occurring within the training set. For example, as is shown in step 265 of FIG. 2, if a tag occurred zero times, once, twice and three times, the Information Gain would be calculated for a cut point between zero and 1,2,3 and for a cut point between 0,1 and 2,3 and also for a cut point between 0,1,2 and 3. The cut-point providing the highest information gain is selected as the cut point. This process can be repeated to provide multiple cut points. For example, if the highest information gain was initially found to occur with a cut-point between a tag frequency of 0 and 1,2,3 then with the documents having a tag frequency of 1,2 and 3, the information gain would further be evaluated with a cut point between 1 and 2,3 and between 1,2 and 3. A second cut point could be provided where the second information gain is highest. In a preferred embodiment, further cut points are not calculated when the number of articles falls below a threshold, for example, 20 articles, or alternatively, if the information gain falls below a threshold. For numeric data, such as entropy, the cut point candidates may be chosen as discrete values, for example, as whole numbers.

Generate a Decision Tree Model for each Instance of the Further Training Set

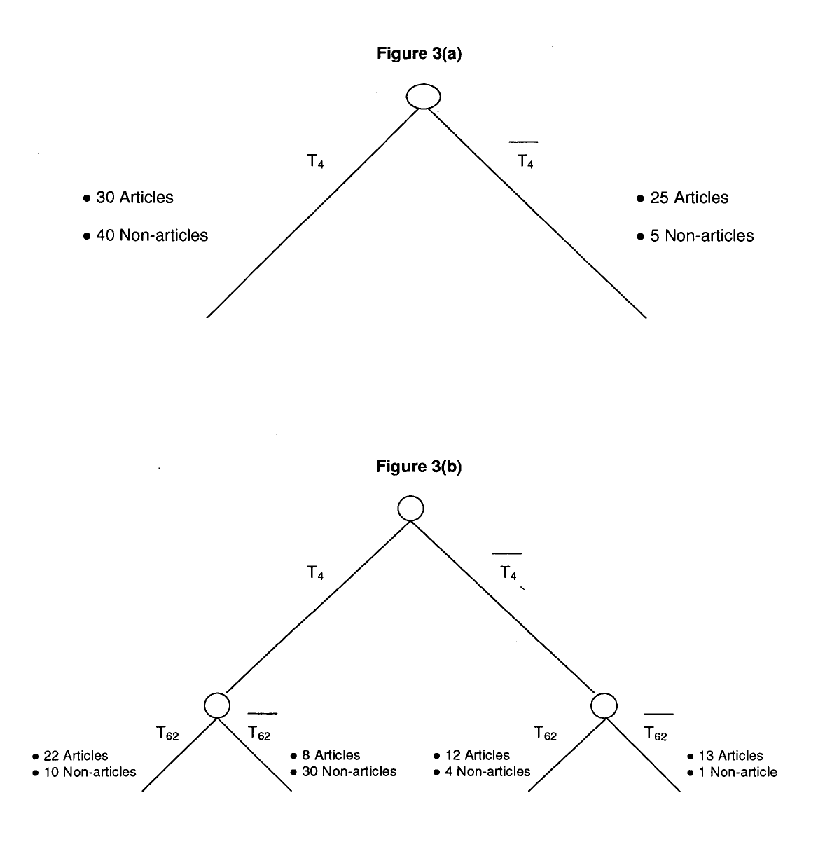

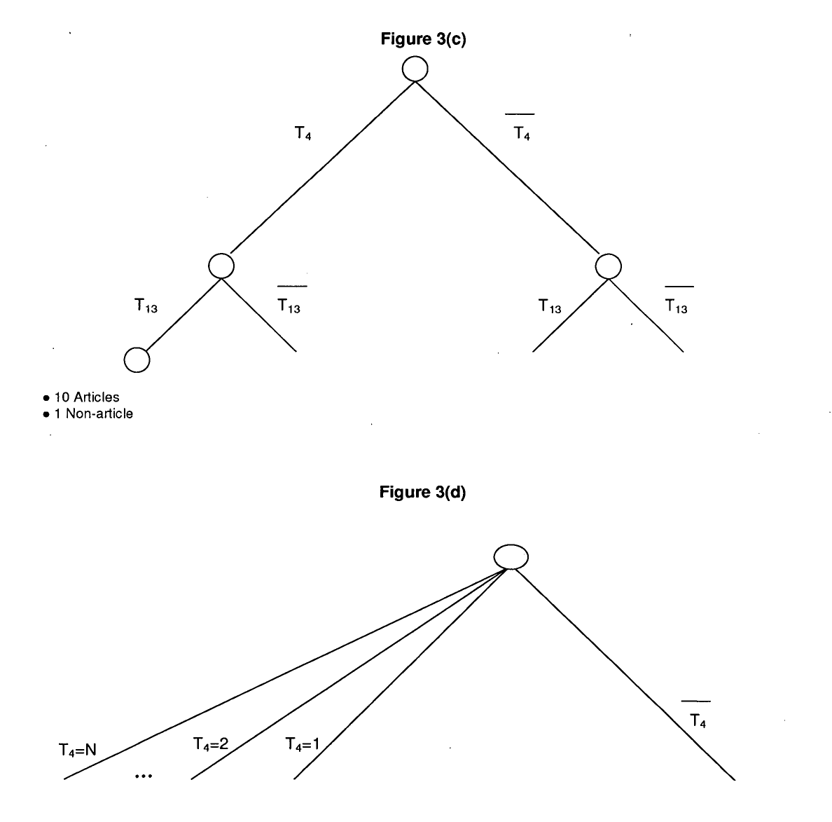

In Step 270 of FIG. 2, a decision Tree Model is created for each instance of the Further Training Sets, as follows:
(a) The Tag or Metric with the highest decision making power is chosen as the first node of the Tree. Referring to FIG. 3, T₄ is chosen because it had the greatest Information Gain.
(b) The instance of the further training set is then sorted according to those documents containing T₄, and those not containing T₄. In each of these two cases, the number of human-labelled articles and non-articles is calculated. With reference to FIG. 3(a) it can be seen that where T₄ exists in a document, 30 of such documents have been human labelled as articles and 40 as non-articles, and where T₄ does not exist, 25 have been human labelled articles and only 5 as non-articles. In tabular form this can be described as follows:

| | |
|---|---|
| T₄ Present | Articles = 30 |
| | Non-articles = 40 |
| T₄ Not Present | Articles = 25 |
| | Non-articles = 5 |

T₄ could have multiple values for frequency of T4 in any particular document. As such, it is also possible to build the decision tree with more than 2 leaves arising from any particular node. This is shown in FIG. 3(d).
(c) The tag with the next highest Information Gain (after T₄, in this example), is further chosen to build the next leaves of the Tree. For example, T₆₂ could be the tag with the next highest Information Gain. FIG. 3(b) shows the Decision Tree with T₆₂ used as a branch of the Tree. In this case the following is observed:

| | T₆₂ Present | T₆₂ Not Present |
|---|---|---|
| T₄ Present | Articles = 22 | Articles = 8 |
| | Non-articles = 10 | Non-articles = 30 |
| T₄ Not Present | Articles = 12 | Articles = 13 |
| | Non-articles = 4 | Non-articles = 1 |

When the aggregate number of articles and non-articles is below a threshold in a particular leaf, in a preferred embodiment the aggregate threshold is twenty (20), (for example, in the above table, T₄ Not Present, T₆₂ Not Present,) then there may be a problem with that leaf not having adequate statistical significance. In other words the prediction or discrimination provided by that leaf may not be adequately reliable.

The invention provides a variety of approaches to addresses this problem of a leaf not having adequate statistical significance:
(a) In one embodiment, the tag which gives rise to the leaf not having statistical significance is not used, and instead the tag with the next highest Information Gain is employed. For example, referring to FIG. 3(c) the Decision Tree is built using T4 as the first node and T13 as the second node.
(b) In a second, alternative embodiment, sub-tree pruning or another method as will be apparent to those skilled in the art is employed to address this problem of a leaf not having adequate statistical significance or being over-determined.
When each Tree has been built the probability for each terminal leaf is calculated. For example, if T₄, T₁₃ gave rise to a terminal leaf, and this leaf containing 10 articles and 1 non-article, then:

P(article|T₄, T₁₃)=10/11=0.91

P(non-article|T₄, T₁₃)=1/11=0.09
This process is repeated to build a decision tree for each instance of the Further Training Sets. In a preferred embodiment it has been found that good results are obtained when thirty (30) different decision trees are built.

In alternate embodiments other approaches could be used to create the machine learning model, including random forest or boosting, or statistical methods such as naïve Bayes.

### Aggregate the Decision Tree Model to Create an Aggregated (Bagging) Decision Tree Model

In the next step of the invention, the decision trees calculated from each instance of the Further Training Sets are aggregated. This is shown as step 280 of FIG. 2.

The aggregation of the decision trees calculated from each instance of the Further Training Sets is carried out by employing LaPlace smoothing. The purpose of the LaPlace smoothing is to provide greater weights to those probabilities calculated from leaves having greater numbers of documents in such leaf. In order to carry out LaPlace smoothing, in one embodiment, the following formulae are employed:

P(article|T)=(n_{c}+(1/c)*L)/(n+L)
Where n_{c} is the number of documents identified as an article in the leaf; n is the total number of documents in that leaf (for that instance of the Further Training Set.); and c is the total number of classes which the document could be classified into, which in an embodiment of the present invention where documents are classified as articles or non-articles, would equal 2.

P(non-article|T)=(n_{c}+(1/c)*L)/(n+L)
Where n_{c} is the number of documents identified as an non-article in the leaf; n is the total number of documents in that leaf (for that instance of the Further Training Set.); and c is the total number of classes which the document could be classified into, which in an embodiment of the present invention where documents are classified as articles or non-articles, would equal 2.
In a preferred embodiment, L=1.
Thus for the example, where P(article|T₄, T₁₃)=10/11 and P(non-article|T₄, T₁₃)=1/11, then

P(article|T)=(10+½*1)/(11+1)=10.5/12=0.875

P(non-article|T)=0.125
Following the Laplace smoothing the P values from the trees are aggregated.

### Use the Aggregated (Bagging) Decision Tree Model to Determine Whether a New Document is an Article or Non-Article and Generate Either an Article or Non-Article Label

In this step (step 285 of FIG. 2) the tags (and numeric metrics) in the new article are determined, and the frequency of the tags are also determined.

The following two amounts are calculated in step 290 of FIG. 2:

P(article)=P(article|T) for all Laplace smoothed leaves in all decision trees arising from the Further Training Sets

P(non-article)=P(non-article|T) for all Laplace smoothed leaves in all decision trees arising from the Further Training Sets.
Where P(article)>P(non-article) the new document is labelled an article and vice-versa. In a preferred embodiment, a threshold may be established which must be exceeded in order for a label to be assigned. For example, only where P(article) is >0.9 or <0.1 is a label assigned.

As will be apparent to those skilled in the art, alternative approaches, which are included within the scope of this invention, may be used to create the decision tree model, for example, random forest approaches.

Associate the Article/Non-Article Label with the New Document and Store such an Association

In the last step of the method (step 300 of FIG. 2) of an embodiment of the present invention, the generated label is associated with the new document (or an identifier of the new document, such as a unique ID) and stored.

In a further embodiment of the present invention the generated label may be used to facilitate the operation of a search or recommendation engine. For example, the search or recommendation engine could not return, in response to a query, documents which had been labelled as “non-articles”.

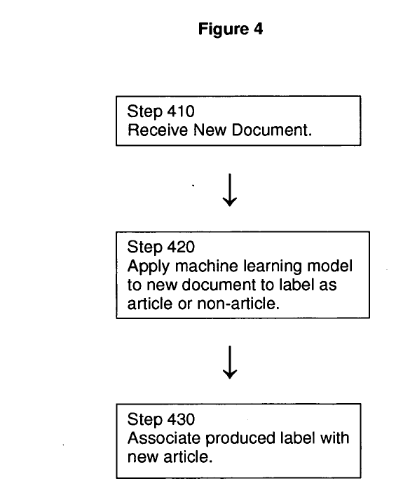

Once a machine learning model has been developed in accordance with the present invention it can be stored or downloaded into a variety of devices. Using such devices, it may be desirable to label a document as an article or non-article in accordance with the following steps as are illustrated in FIG. 4:
(a) receiving a new document (Step 410);
(b) applying the machine learning model to the new document to produce a label of article or non-article (Step 420); and,
(c) associating the produced label with the new document (Step 430).

In an embodiment of the present invention, once a document has been labelled as a non-article, it would not be presented in response to a query given to a search engine, or would not be presented by a recommendation engine. Alternatively, in a further embodiment of the present invention, documents labelled as non-articles would not be assessed or interrogated or considered by a search or recommendation system, so that words they contain would not be a possible source of inaccurate results.

A recommender system carries out the following steps as are known to those skilled in the art:
(a) Receiving information from or relation to a first user, said information including at least one of
   (i) a rating of a first document by the first user;
   (ii) demographic information related to the first user;
   (iii) information relating to a transaction the first user had conducted; or,
   (iv) information relating to content of a document of interest to the first user.
(b) Determining a similarity between the received information and at least one of
   (i) demographic information about a second person;
   (ii) information relating to the content of a second document; or,
   (iii) transaction conducted by a second person.
(c) Recommending to the first user a second document from a set of candidate documents based on the determined similarity.

Each of the above steps is carried out with methods known to those skilled in the art.

In accordance with an embodiment of the present invention, the said second documents do not include documents labelled as non-articles in accordance with the method set out at FIG. 4. In a preferred embodiment, documents labelled as non-articles are not candidates for recommendation as the said second document.

A search engine is a method or system designed to search for information on the World Wide Web, or a sub-set of it, or on a web-site, database or some sub-set of these. Known search engines include Google, All the Web, Info.com, Ask.com, Wikiseek, Powerset, Viewz, Cuil, Boogami, Leapfish, and Inktomi.

In general search engines work according to the following method:
(a) retrieving information from the World Wide Web, database, site or a sub-set of one of these about a plurality of documents;
(b) analyzing the contents or links of the documents;
(c) storing results of this analysis in a database;
(d) receiving a query from a user;
(e) processing the query against the stored results to produce search results; and,
(f) providing the search results to the user.

Each of the above steps of the general operation of a search engine are carried out in accordance with methods known of those skilled in the art. Typically, steps (a)-(c) in the previous paragraph are carried outby a web crawler. If a database of stored results was available then these steps would not be essential to the method of seach engine operation.

In accordance with an embodiment of the present invention, the search engine method also includes the following steps:
(a) labelling the documents as articles or non-articles in accordance with the method set out generally at FIG. 4; and,
(b) excluding from one of: analyzing the contents or links of documents, storing results, or producing search results, documents labelled as non-articles.

In a further embodiment of the present invention, the device is capable of receiving an update to the machine learning model.

Such a device would have input processor, for receiving the new document; memory, for storing the new document and the machine learning model; a processor for determining the tags or other metrics in the new document and for applying the machine learning model to the new document to produce a label of article or non-article. When the label was generated, it would be stored in the memory in association with the new document. Alternatively, the new document and label may not be stored (other than transiently) if the label was to be used immediately by a search or recommendation engine.

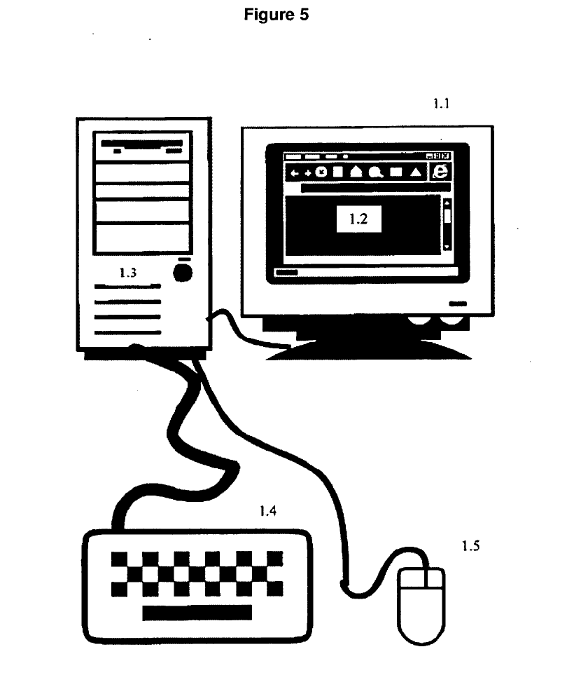

FIG. 5 shows a basic computer system on which the invention might be practiced. The computer system comprises of a display device (1.1) with a display screen (1.2). Examples of display device are Cathode Ray Tube (CRT) devices, Liquid Crystal Display (LCD) Devices etc. The computer system can also have other additional output devices like a printer. The cabinet (1.3) houses the additional essential components of the computer system such as the microprocessor, memory and disk drives. In a general computer system the microprocessor is any commercially available processor of which x86 processors from Intel and 680X0 series from Motorola are examples. Many other microprocessors are available. The computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The computer system also had various input devices like a keyboard (1.4) and a mouse (1.5). The keyboard and the mouse are connected to the computer system through wired or wireless links. The mouse (1.5) could be a two-button mouse, three-button mouse or a scroll mouse. Besides the said input devices there could be other input devices like a light pen, a track ball, etc. The microprocessor executes a program called the operating system for the basic functioning of the computer system. The examples of operating systems are UNIX, WINDOWS and DOS. These operating systems allocate the computer system resources to various programs and help the users to interact with the system. It should be understood that the invention is not limited to any particular hardware comprising the computer system or the software running on it.

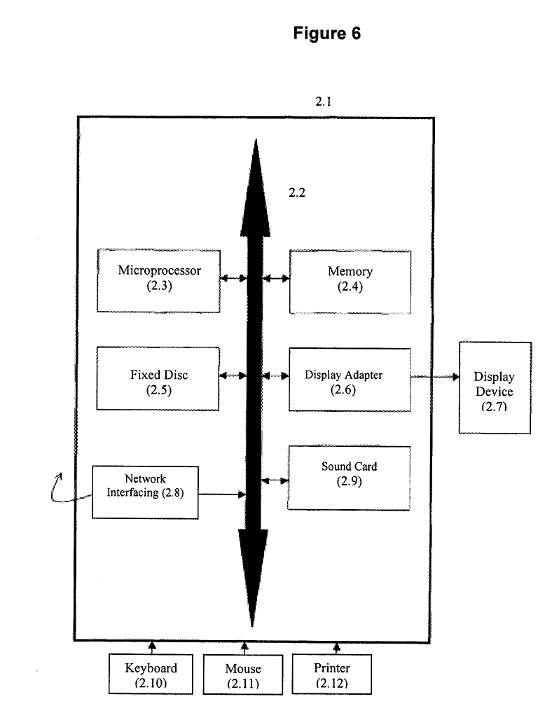

FIG. 6 shows the internal structure of the general computer system of FIG. 5. The computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The system is connected to various input devices like keyboard (2.10) and mouse (2.11) and output devices like printer (2.12). Various configurations of these subsystems are possible. It should also be noted that a system implementing the present invention might use less or more number of the subsystems than described above.

As an embodiment of the present invention, computer media, such as Fixed Drive (2.5), could have statements and instructions for execution by a computer stored on it to carry out the method set out above, which is described schematically in FIG. 2. The Fixed Drive (2.5) could receive such statements and instructions by way of network interface (2.8). These statements and instructions are then executed by microprocessor (2.3). More generally, a computer system apparatus for carrying out this invention comprises means for receiving a new document, means for parsing the document according to tags, means for applying a machine learning model to each tag of the document to determine if the tag or the document contains text; and, means for labelling the document as an article if the means for apply a machine learning model has determined that the tag or the document contains text.

During operation of the system shown in FIG. 6, Memory (2.4) can include in an embodiment of the invention a database stored in Memory (2.4), with a data structure including information resident in a database used by an application program which carries out the statements and instructions for execution by a computer stored on it to carry out the method set out above, which is described schematically in FIG. 2. Memory (2.4) could also include in an embodiment of the invention a table stored in said memory serializing a set of articles and associated URIs such that each article and associated URI has been classified according to the present invention.

What has been described above includes examples of the present invention. It is, of course, not possible to describe every conceivable combination of components or methodologies for purposes of describing the present invention, but one of ordinary skill in the art may recognize that may further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented method for labelling web documents as articles or non-articles comprising the steps of:
(i) receiving a training set comprising documents;
(ii) receiving a set of human generated labels for each document in the training;
(iii) generating a machine learning model based on the content of the document and the corresponding human generated label to generate a predicted label for the document;
(iv) receiving a new document;
(v) applying the machine learning model to the new document to produce a label of article or non-article; and,
(vi) associating the produced label with the new document.

2. The computer-implemented method claimed in claim one where the human generated labels are either article or non-article.

3. The computer-implemented method claimed in claim one where the machine learning model is a decision tree.

4. The computer-implemented method claimed in claim three further comprising the steps:
(a) selecting documents randomly from the training set to produce further training sets;
(b) producing a separate decision tree from each further training set; and,
(c) producing a bagging decision tree from the separate decision trees.

5. The computer-implemented method claimed in claim four where the bagging decision tree is produced by Laplace smoothing the separate decision trees.

6. The computer-implemented method claimed in claim one where the content of the document used to generate the machine learning model includes text within the document.

7. The computer-implemented method claimed in claim one where the content of the document used to generate the machine learning model includes HTML tags within the document.

8. The computer-implemented method claimed in claim seven where the HTML tags are selected from a group of frequently occurring tags.

9. The computer-implemented method claimed in claim three where the decision tree is constructed by selecting tags or metrics having the greatest information gain.

10. The computer-implemented method claimed in claim three where the decision tree is constructed by a random forest approach.

11. The computer-implemented method claimed in claim three where the decision tree is constructed by boosting.

12. The computer-implemented method claimed in claim one where the machine learning model is a naive Bayes model.

13. The computer-implemented method claimed in claim six where the content of the document includes metrics based on the text of the document.

14. The computer-implemented method claimed in claim thirteen where the metric is the entropy.

15. The computer-implemented method claimed in claim thirteen where the metric is the word count of the document.

16. The computer-implemented method claimed in claim three where the decision tree is pruned in accordance with a pre-determined criteria.

17. A computer-implemented method of recommending documents, comprising the steps of:
(a) labelling a set of candidate documents as articles or non-articles by applying a machine-learning model to produce a label of article or non-article, and discarding documents labelled as non-articles;
(b) receiving information from, or relation to, a first user, said information including at least one of:
(i) a rating of a first document by the first user;
(ii) demographic information related to the first user;
(iii) information relating to a transaction the first user conducted; or,
(iv) information relating to content of a document of interest to the first user;
(c) determining a similarity between the received information and at least one of:
(i) demographic information about a second person;
(ii) information relating to the content of a second document; or,
(iii) a transaction conducted by a second person.
(d) recommending to the first user a second document from the set of candidate documents based on the determined similarity.

18. A computer-implemented method for searching for documents comprising the steps of:
(a) retrieving information from the World Wide Web, a database, a web-site or a sub-set of one of these about a plurality of documents;
(b) analyzing the contents or links of the plurality of documents;
(c) labelling each of the plurality of documents as an article or non-article, by applying a machine learning model to produce a label of article or non-article;
(d) storing results of this analysis for each document in a database;
(e) receiving a query from a user;
(f) processing the query against the stored results to produce search results; and,
(g) providing the search results to the user;
where documents labelled as non-articles are excluded from at least one of:
storing results for the document, processing the query against the stored results or providing the search results to the user.

19. An apparatus for article-non-article text classification comprising:
(a) means for receiving a new document;
(b) means for parsing the document according to tags;
(c) means for applying a machine learning model to each tag of the document to determine if the tag or the document contains text; and,
(d) means for labelling the document as an article if the means for apply a machine learning model has determined that the tag or the document contains text.

20. An apparatus for document classification comprising:
(a) an input processor, for receiving a new document;
(b) memory, for storing the new document and a machine learning model; and,
(c) a processor, for determining tags or other metrics in the new document and for applying the machine learning model to the tags or other metrics to produce a label of article or non-article.

21. A computer readable memory having recorded thereon statements and instructions for execution by a computer to carry out the method of claim 1.

22. A memory for storing data for access by an application program being executed on a data processing system, comprising:
a database stored in said memory, said data structure including information resident in a database used by said application program; and including a table stored in said memory serializing a set of articles and associated URIs such that each article and associated URI has been classified according to the apparatus of claim 19.
